(19) United States
(12) Patent Application Publication
(10) Pub. No.: US 2026/0004091 A1
(43) Pub. Date: Jan. 1, 2026

(54) PRODUCT OBJECT INFORMATION TRANSLATION METHOD AND APPARATUS

(71) Applicant: Hangzhou Alibaba International Internet Industry Co., Ltd., Hangzhou (CN)

(72) Inventors: Weiyong XUE, Hangzhou (CN); Hangyu JI, Hangzhou (CN); Hongxiang YAO, Hangzhou (CN); Yu JIN, Hangzhou (CN)

(21) Appl. No.: 19/319,696

(22) Filed: Sep. 4, 2025

Related U.S. Application Data
(63) Continuation of application No. PCT/CN2024/080383, filed on Mar. 6, 2024.

(30) Foreign Application Priority Data
Mar. 8, 2023 (CN) 202310246803.4

(51) Int. Cl. G06F 40/58; G06F 40/14; G06F 40/166

(52) U.S. Cl. CPC G06F 40/58; G06F 40/14; G06F 40/166

(57) ABSTRACT

A machine translation method includes: obtaining product object information of a product object, wherein the product object information includes product description information in a first language; analyzing the product object information to determine product description information that satisfies a translation condition, as to-be-translated information; and performing a translation process on the to-be-translated information into a second language to determine product description information in the second language. It is possible to quickly determine the product description information that needs to be translated, reduce the amount of data for translation, and translate the to-be-translated information in a targeted manner, thereby improving translation efficiency.

### CROSS-REFERENCE TO RELATED APPLICATION

This application is a Continuation Application of International Patent Application No. PCT/CN2024/080383, filed on Mar. 6, 2024, which is based on and claims priority to and benefits of Chinese Patent Application No. 202310246803.4, filed with the China National Intellectual Property Administration on Mar. 8, 2023. The above-referenced applications are incorporated herein by reference in their entirety.

### TECHNICAL FIELD

The present application relates to the field of computer technology, and in particular, to a method, an electronic apparatus, and a storage medium for translating product object information.

### BACKGROUND

With the continuous development of international trade in recent years, the demand for global sales has become increasingly strong and the trend has become more apparent. Cross-border e-commerce platforms are an important medium for connecting global buyers and sellers. Seller (merchant) users can publish product-related information on cross-border e-commerce platforms and conduct related marketing activities, thereby allowing buyer users to understand and purchase their products. If a seller (merchant) user wants to sell a product object to different countries, it is necessary to provide product object information in the language of the corresponding country to facilitate sales in that country.

There are a very large number of seller (merchant) users on a platform, and each seller (merchant) user's store usually sells a plurality of product objects. For example, an electronics product store may sell various brands and models of mobile phones, as well as mobile phone accessories such as chargers, phone cases, etc. As another example, a household goods store may sell various kitchen supplies, cleaning supplies, storage supplies, etc. If all the product object information in a seller (merchant) user's store is translated, even with machine translation, a massive amount of data needs to be translated due to the very large number of seller (merchant) users on the platform. This consumes a great deal of resources, and the translation efficiency is relatively low. Furthermore, for each seller (merchant) user, because the platform cannot guarantee the time of translation, the sales of the product object may be affected, resulting in a poor user experience.

### SUMMARY

Embodiments of the present application provide a method for translating product object information, so as to improve the translation efficiency of product objects.

Accordingly, embodiments of the present application also provide an electronic apparatus and a storage medium for the implementation and application of the above system.

To solve the above problems, an embodiment of the present application discloses a method for translating product object information, the method including:
obtaining product object information of a product object, the product object information including product description information in a first language;
analyzing the product object information to determine product description information that satisfies a translation condition, as to-be-translated information;
performing a translation process on the to-be-translated information into a second language to determine product description information in the second language.

Optionally, the analyzing the product object information to determine the product description information that satisfies the translation condition includes:
verifying the product object information to determine product object information that satisfies a verification rule;
analyzing the product object information that satisfies the verification rule to determine the product description information that satisfies the translation condition.

Optionally, the product object information further includes user level information and a review status;
the verifying the product object information to determine the product object information that satisfies the verification rule includes at least one of the following:
verifying characters of the product description information in the product object information according to a character verification rule to determine product description information that conforms to the character verification rule;
verifying the user level information in the product object information according to a level verification rule to determine product object information where the user level information conforms to the level verification rule;
verifying the review status in the product object information according to a status verification rule to determine product object information where the review status conforms to the status verification rule.

Optionally, the analyzing the product object information that satisfies the verification rule to determine the product description information that satisfies the translation condition includes:
analyzing the product object information to determine translation value information corresponding to the product description information;
matching the translation value information with the translation condition to determine the product description information that satisfies the translation condition.

Optionally, the analyzing the product object information to determine the translation value information corresponding to the product description information includes:
determining a content score and an association score based on the product object information;
performing a weighted calculation on the content score and the association score to determine the translation value information corresponding to the product description information.

Optionally, the step of determining the content score based on the product object information includes:
analyzing according to a type of the product description information to determine the content score of each type of product description information and corresponding first weight information.

Optionally, the product object information further includes: sales region information, a product type, an access volume, and brand information;
the step of determining the association score based on the product object information includes at least one of the following:
determining a language score and second weight information based on the sales region information of the product object information;
determining an access frequency score and third weight information based on the product type of the product object information;
determining an access volume score and fourth weight information based on the access volume of the product object information;
determining a brand score and fifth weight information based on the brand information of the product object information.

Optionally, the matching the translation value information with the translation condition to determine the product description information that satisfies the translation condition includes:
determining whether the translation value information of the product description information is greater than a value threshold;
if the translation value information is greater than the value threshold, determining that the product description information satisfies the translation condition.

Optionally, the performing the weighted calculation on the content score and the association score to determine the translation value information corresponding to the product description information includes:
performing a weighted calculation on the content score and the association score of each type of product description information to determine the translation value information corresponding to each type of product description information;
the matching the translation value information with the translation condition to determine the product description information that satisfies the translation condition includes:
respectively determining whether the translation value information of each type of product description information is greater than a value threshold;
if the translation value information is greater than the value threshold, determining that the type of product description information satisfies the translation condition.

Optionally, the method further includes:
combining each type of product description information in the second language to generate a product page of the product object in the second language.

An embodiment of the present application also discloses a method for translating product object information, the method including:
providing a translation service to a client terminal;
receiving a product object identifier fed back through the translation service;
obtaining product object information of a product object based on the product object identifier, the product object information including product description information in a first language;
analyzing the product object information to determine product description information that satisfies a translation condition, as to-be-translated information;
performing a translation process on the to-be-translated information into a second language to determine product description information in the second language;
feeding back the product description information in the second language based on the translation service.

An embodiment of the present application also discloses a method for translating product object information, the method including:
displaying an editing page, the editing page including an editing control;
in response to a trigger of the editing control, determining a product object identifier of a to-be-translated product object;
generating a translation request based on the product object identifier and sending the translation request;
receiving a product page of the product object in a second language, wherein the product page of the product object in the second language is generated by combining each type of product description information in the second language, the each type of product description information in the second language is obtained by translating to-be-translated information, the to-be-translated information is determined based on product description information that satisfies a translation condition, and the product description information that satisfies the translation condition is determined based on an analysis of product object information.

An embodiment of the present application also discloses a method for translating product object information, the method including:
providing an editing page, the editing page including an editing control, for determining a product object identifier of a to-be-translated product object based on the editing control;
receiving a translation request and obtaining the product object identifier from the translation request;
obtaining product object information of a product object based on the product object identifier, the product object information including product description information in a first language;
analyzing the product object information to determine product description information that satisfies a translation condition, as to-be-translated information;
performing a translation process on the to-be-translated information into a second language to determine product description information in the second language;
combining each type of product description information in the second language to generate a product page of the product object in the second language;
feeding back the product page of the product object in the second language.

An embodiment of the present application also provides an electronic apparatus, including: a processor, and a memory communicatively connected to the processor; the memory stores computer-executable instructions;
the processor executes the computer-executable instructions stored in the memory to implement the method as described in the embodiments of the present application.

An embodiment of the present application also provides a computer-readable storage medium, wherein the computer-readable storage medium stores computer-executable instructions, and the computer-executable instructions, when executed by a processor, are used to implement the method as described in the embodiments of the present application.

Compared with the prior art, embodiments of the present application include the following advantages:

In the embodiments of the present application, product object information of a product object is analyzed, wherein the product object information includes product description information in a first language. Product description information that satisfies a translation condition is determined through analysis and used as to-be-translated information, thereby quickly filtering the product description information that needs to be translated and reducing the amount of data for translation. Then, a translation process is performed on the to-be-translated information into a second language to determine the product description information in the second language. The to-be-translated information is translated in a targeted manner, which improves translation efficiency, guarantees translation time, and enhances user experience.

### BRIEF DESCRIPTION OF THE DRAWINGS

FIG. 1 is a schematic flowchart of a method for translating product object information according to an embodiment of the present application.

FIG. 2 is a schematic flowchart of another method for translating product object information according to an embodiment of the present application.

FIG. 3 is a schematic diagram of an exemplary translation apparatus according to an embodiment of the present application.

FIG. 4 is a schematic interaction diagram of an example of a method for translating product object information according to an embodiment of the present application.

FIG. 5 is a schematic flowchart of another method for translating product object information according to an embodiment of the present application.

FIG. 6 is a schematic structural diagram of a translation apparatus according to an embodiment of the present application.

FIG. 7 is a schematic structural diagram of an optional embodiment of a translation apparatus according to an embodiment of the present application.

FIG. 8 is a schematic structural diagram of another translation apparatus according to an embodiment of the present application.

FIG. 9 is a schematic structural diagram of an exemplary apparatus provided by an embodiment of the present application.

### DETAIL DESCRIPTION OF THE EMBODIMENTS

To make the aforementioned objectives, features, and advantages of the present application more apparent and understandable, the present application will be further described in detail below with reference to the accompanying drawings and specific embodiments.

Embodiments of the present application can be applied to translation scenarios, such as translating data of product objects. Translation is the act of converting information from one language into another on the basis of accuracy, fluency, and elegance, such as converting text from a first language to text in a second language.

As trade internationalization continues to deepen, machine translation is playing an increasingly important role in fields such as e-commerce, medicine, and spoken language. In machine translation, bilingual parallel corpora play a fundamental role in training machine translation models. The construction of corpus systems originated from bilingual corpora provided by news organizations, official institutions, etc. With the rapid development of the internet and the deepening of trade globalization, obtaining bilingual corpora from the internet has also become an important source for various corpus systems.

As machine translation is more widely and deeply applied in production and daily life, the requirements for domain-specific machine translation are becoming more common. Examples include the demand for machine translation in the e-commerce domain, the news domain, the automotive domain, the medical domain, and so on. A relatively common example is the translation demand for cross-border e-commerce, which requires the accuracy and professional style of the e-commerce translation system. Constructing these professional domain-specific translation systems requires domain-specific bilingual data that serves as a fundamental component. And filtering domain-specific bilingual corpora from bilingual corpus data requires a domain-specific filtering method. The translation in the following embodiments of the present application may include domain-specific translation or other translations.

The embodiments of the present application take the translation of data for product objects in the e-commerce domain as an example, which can automatically filter the product description information that needs to be translated and perform the translation, thereby improving translation efficiency, reducing the cumbersome process of users performing translation themselves, and improving efficiency.

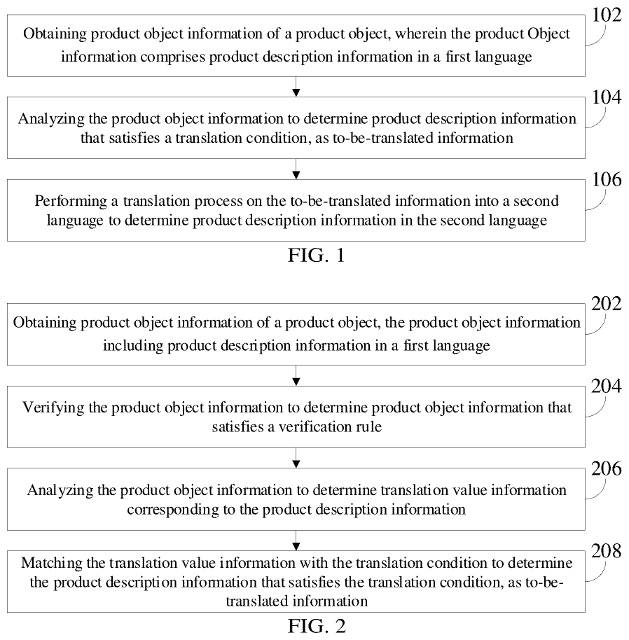

Referring to FIG. 1, a schematic flowchart of a method for translating product object information according to an embodiment of the present application is shown.

Step 102, obtaining product object information of a product object, the product object information including product description information in a first language.

The product object information of the product object can be obtained from the database of an e-commerce website, or the product object information uploaded by a seller user can be obtained, such as product object information published by the seller user on the e-commerce website.

The product object information is various data associated with the product object, including product description information, user information, sales information, etc. The description information of the product object is information used to describe the product object, including a product object identifier, a product name, a product type, product page data, etc. of the product object. The product page data includes: a title, an image, a price, an inventory quantity, page description body text, and other data. The user information is information describing a user, including a user identifier, a user name, user level information, a registration time, etc. The sales information is sales information of the product object in the seller user's store, such as a sales volume, an access volume, brand information, a sales region, a review status, etc. of the product object.

In the embodiments of the present application, the product object information of the seller user is usually uploaded and published based on a certain language, which is taken as the first language. If this product object is to be sold in a region where a language different from the first language is used, such as a second language, it is necessary to convert the product object information in the first language into product object information in the second language.

Step 104, analyzing the product object information to determine product description information that satisfies a translation condition, as to-be-translated information.

After obtaining the product object information, it can be determined based on the product object information whether its product description information needs to be translated, and if translation is needed, which product object information needs to be translated. Therefore, other information in the product object information, such as sales information and user information, can be combined for analysis to determine the product description information that satisfies the translation condition.

In particular, the analysis of the product object may include an information usability analysis and a translation decision-making process. The usability analysis determines whether the product description information needs to be translated, thereby establishing the necessity of translating each part. The translation strategy is used to determine which portions of the product description information require translation by deciding the importance of each part. The step of analyzing the product object information to determine the product description information that satisfies the translation condition includes: first, verifying the product object information to determine product object information that satisfies a verification rule; and second, analyzing the product object information that satisfies the verification rule to determine the product description information that satisfies the translation condition. The verification can be performed across a plurality of dimensions, such as the intrinsic value of the content, the level of the associated user, and whether the platform has reviewed the information. After identifying the product object information that satisfies the verification rule, a further analysis may be performed. For example, an access history and sales region of the product object can be analyzed to ultimately determine the product description information that satisfies the translation condition.

In particular, the product object information further includes user level information and a review status; the verification rule includes at least one of the following: a character verification rule, a level verification rule, and a status verification rule. In particular, the verifying the product object information includes at least one of the following:
verifying characters of the product description information in the product object information according to a character verification rule to determine product description information that conforms to the character verification rule; wherein, the character verification rule refers to a rule for verifying characters in the product description information. A character verification rule can be generated to determine characters that need to be translated or do not need to be translated. The characters can be a certain type of character, for example, for characters such as numbers, translation is usually not required. It can also be a character corresponding to a certain type of information, for example, for the model number of a product object, translation is usually not required either. In contrast, the title, body text, etc., in the product object description information are mainly used to describe the product object, and their translation value is relatively high. Therefore, the characters of the product description information can be verified according to the character verification rule. It is determined whether the character verification rule is satisfied. If the character verification rule is not satisfied, the character is ignored and does not need to be translated. If the character verification rule is satisfied, the product description information is retained for subsequent processing.
verifying the user level information according to a level verification rule to determine product object information where the user level information conforms to the level verification rule; the level verification rule refers to a rule for verifying the user level. The translation value of the product object information differs for different user levels. For example, some enterprise merchant users have a higher probability of selling their product objects to different countries, and the corresponding translation value is higher. As another example, some seller users have lower sales volumes for the product objects in their stores and a lower probability of selling to different countries, and the corresponding translation value is lower. Therefore, the user level information can be verified according to the level verification rule. It is determined whether the user level information satisfies the level verification rule. If the level verification rule is not satisfied, the product object information corresponding to the user is ignored. If the level verification rule is satisfied, the product object information corresponding to the user is retained for subsequent processing.
verifying the review status according to a status verification rule to determine product object information where the review status conforms to the status verification rule. When a seller or merchant user publishes product description information of a product object on an e-commerce website, the e-commerce website usually reviews the product description information to determine whether there is content that does not meet requirements. If there is content that does not meet requirements, it needs to be corrected before being published again. Therefore, whether the product description information of the product object has been reviewed is related to whether it can be published, and the translation value of product description information that cannot be published is lower. Therefore, a review status of the product description information can be set in the product object information, the review status including reviewed and not reviewed. The review status in the product object information is verified according to the status verification rule to determine that the product object information with a reviewed status satisfies the status verification rule, and accordingly, the product object information corresponding to the user is retained for subsequent processing.

After determining the product object information that satisfies the verification rule, a translation decision can be continued based on the product object information to determine the product description information that needs to be translated.

The analyzing the product object information that satisfies the verification rule to determine the product description information that satisfies the translation condition includes: analyzing the product object information to determine translation value information corresponding to the product description information; and matching the translation value information with the translation condition to determine the product description information that satisfies the translation condition. The product object information can be analyzed by combining various factors such as the content, sales volume, and sales region of the product object to determine the translation value information corresponding to the product description information. The translation value information is used to measure the value of the product description information being translated. For example, the translation value of the product description information of a product object with a higher sales volume is higher. As another example, because a title is usually displayed when searching for and displaying a product object, and a user does not necessarily visit the detailed information page to purchase the product object, the value of the title can be higher than that of the detailed information. For example, the weight of the title is set to be higher than the weight of the detailed information. The translation condition can be set based on the translation value information. For example, if the translation value information is represented by a numerical value, the translation condition can be defined as the translation value information satisfying a specified threshold. Alternatively, if the translation value information is certain descriptive content, a condition corresponding to that content can be set, such as the translation condition being certain specified content (e.g., a title). Subsequently, the translation value information is matched against the translation condition to determine the product description information that satisfies the translation condition.

The analyzing the product object information to determine the translation value information corresponding to the product description information includes: determining a content score and an association score based on the product object information; and performing a weighted calculation on the content score and the association score to determine the translation value information corresponding to the product description information. For the translation value information corresponding to the product description information, the content score and the association score of the product object can be determined based on the product object information. In particular, the content score is used to measure the value of translation from the perspective of the content of the product description information, and the association score is used to measure the value of translation of the product description information from a dimension other than the content, such as sales volume. Feature analysis can be performed on the content and other data separately, and then the corresponding score can be determined based on the features. Furthermore, the weight information corresponding to each dimension can be determined, and then the weight information can be used to weight the content score and the association score respectively, and then the translation value information corresponding to the product description information can be calculated.

The step of determining the content score based on the product object information includes: analyzing according to a type of the product description information to determine the content score of each type of product description information and corresponding first weight information. The product description information is used to describe the product object, and can be divided into types according to the content, such as title, detailed information, product parameters, product images, etc. Different content scores can be set for different types of product description information, and different weight information can be set for different types of product description information, thereby determining the content score and the first weight information corresponding to the product description information according to the type.

The product object information further includes: sales region information, a product type, an access volume, and brand information. The sales region information refers to the sales region information of the product object or the store where the product object is located, which includes the region currently being sold and the region desired for sale. The region can be determined based on geographical dimensions, such as being in certain countries, regions, or continents. The product type refers to the type information of the product object, such as department store goods, electrical appliances, food, etc., or a sub-type such as kitchen appliances under electrical appliances. The access volume refers to the situation of the product object being accessed, which can be the number of accesses, access frequency, etc. The brand information refers to the brand information to which the product object belongs. The step of determining the association score based on the product object information includes: determining a language score and second weight information based on the sales region information; determining an access frequency score and third weight information based on the product type; determining an access volume score and fourth weight information based on the access volume; and determining a brand score and fifth weight information based on the brand information. The sales region information of the product object can be used to determine the region where the seller (merchant) user is currently selling or wishes to sell. Language information, such as Chinese, English, Japanese, Korean, etc., is determined based on the sales region, and a language score and corresponding second weight information are determined based on the language information. The product type of the product object information is determined, and the type-related access information corresponding to the product type is determined. In different regions and different seasons, the product objects of interest may differ. For example, in low-latitude countries or in summer, there is more interest in heat prevention products such as sun protection clothing, sunscreen, and air conditioners, resulting in a higher access volume and access frequency. Conversely, in high-latitude regions or in winter, there is typically more interest in cold prevention products such as down jackets, electric heaters, and snow boots, also resulting in a higher access volume and access frequency. Therefore, the product type can be combined with the access situation to determine an access frequency score and third weight information associated with the product type. The access volume associated with the product object can also be obtained, such as the number of accesses and access frequency of the product object within a certain period, or the number of accesses and access frequency of the store where the product object is located within a certain period. An access volume score can be determined based on the access volume, for example, by determining access volume parameters based on a threshold satisfied by the number of accesses or access frequency. Its corresponding fourth weight information can also be obtained. The brand information in the product object information can also be obtained. Based on the brand to which the product object belongs, a corresponding brand score is determined, for example, based on whether the brand is on a specified list or the level of the brand on a specified list, thereby determining the brand score and the fifth weight information.

The above language score can be weighted according to the second weight information, the access frequency score can be weighted according to the third weight information, the access volume score can be weighted according to the fourth weight information, and the brand score can be weighted according to the fifth weight information. The respective weighted scores are summed to obtain the corresponding association score.

The performing the weighted calculation on the content score and the association score to determine the translation value information corresponding to the product description information includes: performing a weighted calculation on the content score and the association score of each type of product description information to determine the translation value information corresponding to each type of product description information. The above language score can be weighted according to the second weight information, the access frequency score can be weighted according to the third weight information, the access volume score can be weighted according to the fourth weight information, and the brand score can be weighted according to the fifth weight information. The respective weighted scores are summed to obtain the corresponding weighted association score. The content score of the product description information can be weighted according to the first weight, and the weighted content score and the weighted association score can be summed to obtain the translation value information corresponding to each type of product description information.

The matching the translation value information with the translation condition to determine the product description information that satisfies the translation condition includes: respectively determining whether the translation value information of each type of product description information is greater than a value threshold; if the translation value information is greater than the value threshold, determining that the type of product description information satisfies the translation condition. The translation value information of each type of product description information can be compared with a value threshold respectively to determine whether it is greater than the value threshold. If the translation value information is greater than the value threshold, it is determined that the type of product description information satisfies the translation condition, and this product description information can be subsequently translated. If the translation value information is not greater than the value threshold, it is determined that the type of product description information does not satisfy the translation condition, and this product description information is not translated subsequently.

Thus, by verifying and making a translation decision on the product object information, the product description information that satisfies the translation condition is determined as the to-be-translated information.

Step 106, performing a translation process on the to-be-translated information into a second language to determine product description information in the second language.

The translation process is performed on the to-be-translated information into the second language. The second language can be determined based on the region where the product object is to be sold, and the product description information in the second language is obtained through translation.

In summary, the product object information of the product object is analyzed, wherein the product object information includes product description information in a first language. The product description information that satisfies a translation condition is determined through analysis and used as to-be-translated information, thereby quickly determining the product description information that needs to be translated and reducing the amount of data for translation. Then, a translation process is performed on the to-be-translated information into a second language to determine the product description information in the second language. The to-be-translated information is translated in a targeted manner, which improves translation efficiency.

In an embodiment of the present application, each type of product description information in the second language can also be combined to generate a product page of the product object in the second language. Each type of product description information in the second language can be obtained. Product description information not translated into the second language, such as numbers, model numbers, etc., can be directly obtained. Other product description information that is ignored due to rule matching, decision-making, and other reasons may be either obtained or ignored. Based on the requirements for constructing the page, each type of product description information in the second language and other types of product description information are combined to generate the product page of the product object in the second language, so that it can be sold in environments such as e-commerce websites corresponding to the second language.

On the basis of the above embodiments, an embodiment of the present application also provides a method for translating product object information, which can combine analysis and decision-making of the type, content, etc., of the product object to determine the product description information that needs to be translated, improving translation efficiency.

Referring to FIG. 2, a schematic flowchart of another method for translating product object information according to an embodiment of the present application is shown.

Step 202, obtaining product object information of a product object, the product object information including product description information in a first language.

In the embodiments of the present application, a seller or merchant user can indicate a product object identifier of the product object to be translated, so that the server terminal queries the database based on the product object identifier to obtain the product object information of the product object. In some other scenarios, the user can also upload the product description information in the first language to the server terminal when creating or needing to create a web page in the second language, thereby obtaining other product object information and performing subsequent processing.

Step 204, verifying the product object information to determine product object information that satisfies a verification rule.

The product object information further includes user level information and a review status; the verifying the product object information to determine the product object information that satisfies the verification rule includes at least one of the following: verifying characters of the product description information in the product object information according to a character verification rule to determine product description information that conforms to the character verification rule; verifying the user level information in the product object information according to a level verification rule to determine product object information where the user level information conforms to the level verification rule; verifying the review status in the product object information according to a status verification rule to determine product object information where the review status conforms to the status verification rule. The product object information that satisfies the verification rule can be analyzed to determine the product description information that satisfies the translation condition.

Step 206, analyzing the product object information to determine translation value information corresponding to the product description information.

The analyzing the product object information to determine the translation value information corresponding to the product description information includes: determining a content score and an association score based on the product object information; performing a weighted calculation on the content score and the association score to determine the translation value information corresponding to the product description information.

The step of determining the content score based on the product object information includes: analyzing according to a type of the product description information to determine the content score of each type of product description information and corresponding first weight information.

The product object information further includes: sales region information, a product type, an access volume, and brand information; the step of determining the association score based on the product object information includes: determining a language score and second weight information based on the sales region information of the product object information; determining a product type based on the product object information and determining an access frequency score and third weight information based on the product type; determining an access volume score and fourth weight information based on the access volume of the product object information; determining a brand score and fifth weight information based on the brand information of the product object information.

Step 208, matching the translation value information with the translation condition to determine the product description information that satisfies the translation condition, as to-be-translated information.

The matching the translation value information with the translation condition to determine the product description information that satisfies the translation condition includes: determining whether the translation value information of the product description information is greater than a value threshold; if the translation value information is greater than the value threshold, determining that the product description information satisfies the translation condition.

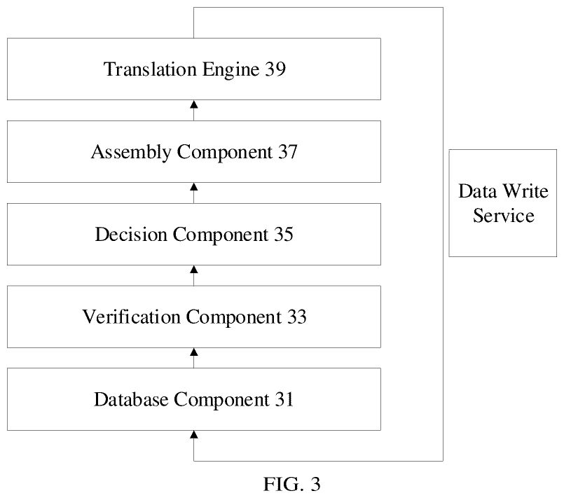

On the basis of the above embodiments, an embodiment of the present application provides a translation apparatus, deployed on a server terminal, such as a cloud server terminal, as shown in FIG. 3. The translation apparatus includes: a database component 31, a verification component 33, a decision component 35, an assembly component 37, and a translation engine 39. In particular, the database component 31 is configured to store data, which may include product object information of product objects, and may also include translated information and to-be-translated information, etc. The verification component 33 is configured to perform data verification, and the verification component 33 can be set with corresponding verification rules. The decision component 35 is configured to make a decision on translation, which can decide the product description information that needs to be translated as to-be-translated information. The assembly component 37 is configured to assemble the to-be-translated information, which can call the data service of the corresponding language to perform translation-related assembly processing. The translation engine 39 is configured to perform translation processing, and the translated information obtained from the translation can be stored in the database component.

Through the above translation apparatus, translation services can be provided. For example, the translation apparatus is set up on a cloud server terminal, so that a seller (merchant) user can use the translation service to select a product object for sale in a store or certain selected product objects, filter the to-be-translated information of the product object, and translate it into product description information in a second language.

After the translation apparatus determines the product object that needs to be translated, the verification component 33 can be called to obtain the product object information of the product object from the database component 31. Then, the product object information is verified to determine the product object information that satisfies the verification rule. In particular, the verification component 33 can verify the characters of the product description information in the product object information according to a character verification rule to determine the product description information that conforms to the character verification rule; and/or, verify the user level information in the product object information according to a level verification rule to determine the product object information where the user level information conforms to the level verification rule; and/or, verify the review status in the product object information according to a status verification rule to determine the product object information where the review status conforms to the status verification rule.

In some other scenarios, some product description information of a product object has been translated before, but has been subsequently modified, for example, the title of the product has been modified. Accordingly, it can also be detected based on an update rule whether the product description information has been translated or has changed, to determine whether translation or re-translation is needed.

The verification component 33 sends the verified product object information to the decision module 35, and the decision module 35 determines the product description information that needs to be translated in the product object based on the product object information. The decision component 35 analyzes the product object information that satisfies the verification rule to determine the product description information that satisfies the translation condition. This analysis involves the decision component 35 determining translation value information corresponding to the product description information and then matching this information with a translation condition. In some optional embodiments, the decision component determines a content score and an association score based on the product object information, and then performs a weighted calculation on these scores to determine the translation value information. The process of determining the content score includes analyzing the product description information by type to determine a content score and a corresponding first weight for each type. The product object information may also include sales region information, a product type, an access volume, and brand information. The process of determining the association score includes at least one of: determining a language score and second weight information from the sales region information; determining an access frequency score and third weight information from the product type; determining an access volume score and fourth weight information from the access volume; or determining a brand score and fifth weight information from the brand information. Subsequently, the decision component can determine if the translation value information exceeds a value threshold to confirm that the product description information satisfies the translation condition.

The decision component 35 performs a weighted calculation on the content score and the association score of each type of product description information to determine the translation value information corresponding to each type of product description information; and respectively determines whether the translation value information of each type of product description information is greater than the value threshold; if the translation value information is greater than the value threshold, it is determined that the type of product description information satisfies the translation condition.

The decision component 35 can pass each type of product description information that satisfies the translation condition as to-be-translated information to the translation engine 39. In particular, the assembly component 37 can determine the second language that needs to be translated, call the data service corresponding to the second language for assembly, send the relevant parameters to the translation engine 39, and the translation engine 39 performs translation processing on the to-be-translated information, translating the product description information in the first language into product description information in the second language. The translated product description information in the second language is written into the corresponding database table of the database component. Thus, the product description information in the second language can be saved for use when the corresponding seller or merchant user needs it.

Thus, the translation apparatus and corresponding translation service can be provided on the server terminal, filtering the information of the product object that the user needs to translate, making a decision on the product description information that needs to be translated, and performing the translation, improving translation efficiency.

On the basis of the above embodiments, an embodiment of the present application provides a method for translating product object information, which can perform translation of product description information based on a user's request and generate a product page in a second language.

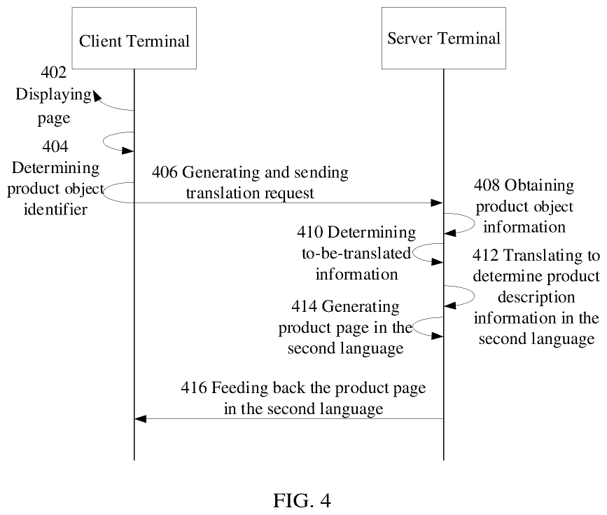

Referring to FIG. 4, a schematic interaction diagram of an example of a method for translating product object information according to an embodiment of the present application is shown.

Step 402, a client terminal displays an editing page.

A seller user, merchant user, etc., can request an editing page, receive page data of the editing page from a server terminal, parse the page data, and display the editing page. The editing page can be a page for editing a product object of a store. The editing page includes an editing control for editing the product object. For example, some controls can provide services such as translation, and some other controls can indicate that the product object is to be listed in a region of another language, etc.

Step 404, the client terminal, in response to a trigger of the editing control, determines a product object identifier of a to-be-translated product object.

For example, a to-be-translated product object is selected or entered in a translation control, or a to-be-translated product object and a corresponding language are indicated or entered in a publishing control, thereby triggering the corresponding control to send a translation instruction. In response to the translation instruction, the product object identifier of the to-be-translated product object is determined. In the embodiments of the present application, the seller user, merchant user, etc., who provides the product object has a certain degree of autonomous decision-making ability, such as the seller being able to express the country and region where the product is sold, and accordingly, parameters such as the second language that needs to be translated can be determined.

Step 406, the client terminal generates a translation request based on the product object identifier and sends the translation request.

The product object identifier of the to-be-translated product object can be used as a request parameter to generate a translation request. The request parameters can also include second language parameters, translation content parameters, etc. In particular, the translation content can be the product description information that the user determines needs to be translated.

Step 408, a server terminal obtains product object information of a product object based on the product object identifier, the product object information including product description information in a first language.

Step 410, the server terminal analyzes the product object information to determine product description information that satisfies a translation condition, as to-be-translated information.

In particular, the analyzing the product object information to determine the product description information that satisfies the translation condition includes: verifying the product object information to determine product object information that satisfies a verification rule; and analyzing the product object information that satisfies the verification rule to determine the product description information that satisfies the translation condition.

The product object information further includes user level information and a review status; the verifying the product object information to determine the product object information that satisfies the verification rule includes at least one of the following: verifying characters of the product description information in the product object information according to a character verification rule to determine product description information that conforms to the character verification rule; verifying the user level information in the product object information according to a level verification rule to determine product object information where the user level information conforms to the level verification rule; or verifying the review status in the product object information according to a status verification rule to determine product object information where the review status conforms to the status verification rule.

The analyzing the product object information that satisfies the verification rule to determine the product description information that satisfies the translation condition includes: analyzing the product object information to determine translation value information corresponding to the product description information; and matching the translation value information with the translation condition to determine the product description information that satisfies the translation condition.

The analyzing the product object information to determine the translation value information corresponding to the product description information includes: determining a content score and an association score based on the product object information; and performing a weighted calculation on the content score and the association score to determine the translation value information corresponding to the product description information.

The step of determining the content score based on the product object information includes: analyzing according to a type of the product description information to determine the content score of each type of product description information and corresponding first weight information.

The product object information further includes: sales region information, a product type, an access volume, and brand information; the step of determining the association score based on the product object information includes at least one of the following: determining a language score and second weight information based on the sales region information of the product object information; determining a product type based on the product object information and determining an access frequency score and third weight information based on the product type; determining an access volume score and fourth weight information based on the access volume of the product object information; or determining a brand score and fifth weight information based on the brand information of the product object information.

The matching the translation value information with the translation condition to determine the product description information that satisfies the translation condition includes: determining whether the translation value information of the product description information is greater than a value threshold; and if the translation value information is greater than the value threshold, determining that the product description information satisfies the translation condition.

The performing the weighted calculation on the content score and the association score to determine the translation value information corresponding to the product description information includes: performing a weighted calculation on the content score and the association score of each type of product description information to determine the translation value information corresponding to each type of product description information; the matching the translation value information with the translation condition to determine the product description information that satisfies the translation condition includes: respectively determining whether the translation value information of each type of product description information is greater than a value threshold; and if the translation value information is greater than the value threshold, determining that the type of product description information satisfies the translation condition.

Step 412, the server terminal performs a translation process on the to-be-translated information into a second language to determine product description information in the second language.

In some optional embodiments, the product description information in the second language can also be fed back to the client terminal, and the client terminal can display it on the editing page, and the user can adjust the translated sentences accordingly.

Step 414, the server terminal combines each type of product description information in the second language to generate a product page of the product object in the second language.

Step 416, the server terminal feeds back the product page of the product object in the second language to the client terminal.

The user can view the product page of the product object in the second language on the client terminal side, and can also edit and adjust the layout of the page and add translated content, etc.

On the basis of the above embodiments, an embodiment of the present application provides a method for translating product object information, which can generate a translation service on a cloud terminal and provide it to a client terminal, so that the client terminal can call the service to perform translation of product description information. For example, applied in a Software as a Service (SaaS) scenario, the above translation processing is encapsulated as a translation service, and the client terminal can call the service through a corresponding interface to perform filtering and translation processing of product description information.

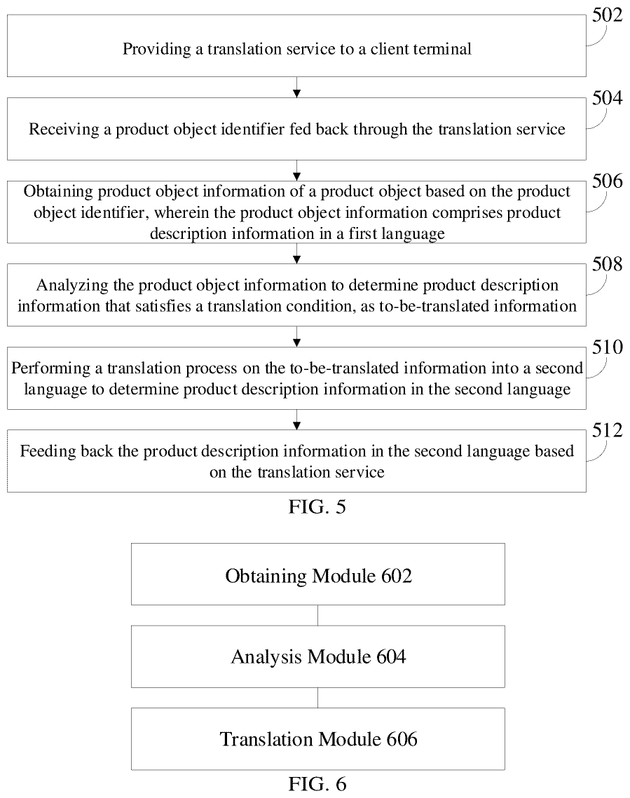

Referring to FIG. 5, a schematic flowchart of another method for translating product object information according to an embodiment of the present application is shown.

Step 502, providing a translation service to a client terminal.

Step 504, receiving a product object identifier fed back through the translation service.

The translation processing is encapsulated as a translation service and provided to the user. The user can call the translation service through the client terminal. In particular, an interface for the translation service can be specified, and the client terminal accesses the translation service through the interface. For a seller (merchant) user, the product object to be translated is a product object sold in the store, and the corresponding product object information is stored on the server terminal. When calling the translation service through the interface, the product object identifier of the product object that needs to be translated can be fed back to the cloud server terminal. For example, a translation entry corresponding to the interface of the translation service is provided on the editing page of the product object in the store, and in response to a trigger of the translation entry, the product object identifier is received.

Step 506, obtaining product object information of a product object based on the product object identifier, the product object information including product description information in a first language.

After receiving one or a plurality of product object identifiers translated by the interface corresponding to the translation service, the database can be accessed based on the product object identifiers to obtain the product object information of the product object.

Step 508, analyzing the product object information to determine product description information that satisfies a translation condition, as to-be-translated information.

In particular, the analyzing the product object information to determine the product description information that satisfies the translation condition includes: verifying the product object information to determine product object information that satisfies a verification rule; and analyzing the product object information that satisfies the verification rule to determine the product description information that satisfies the translation condition.

The product object information further includes user level information and a review status; the verifying the product object information to determine the product object information that satisfies the verification rule includes at least one of the following: verifying characters of the product description information in the product object information according to a character verification rule to determine product description information that conforms to the character verification rule; verifying the user level information in the product object information according to a level verification rule to determine product object information where the user level information conforms to the level verification rule; or verifying the review status in the product object information according to a status verification rule to determine product object information where the review status conforms to the status verification rule.

The analyzing the product object information that satisfies the verification rule to determine the product description information that satisfies the translation condition includes: analyzing the product object information to determine translation value information corresponding to the product description information; and matching the translation value information with the translation condition to determine the product description information that satisfies the translation condition.

The analyzing the product object information to determine the translation value information corresponding to the product description information includes: determining a content score and an association score based on the product object information; and performing a weighted calculation on the content score and the association score to determine the translation value information corresponding to the product description information.

The step of determining the content score based on the product object information includes: analyzing according to a type of the product description information to determine the content score of each type of product description information and corresponding first weight information.

The product object information further includes: sales region information, a product type, an access volume, and brand information; the step of determining the association score based on the product object information includes at least one of the following: determining a language score and second weight information based on the sales region information of the product object information; determining a product type based on the product object information and determining an access frequency score and third weight information based on the product type; determining an access volume score and fourth weight information based on the access volume of the product object information; or determining a brand score and fifth weight information based on the brand information of the product object information.

The matching the translation value information with the translation condition to determine the product description information that satisfies the translation condition includes: determining whether the translation value information of the product description information is greater than a value threshold; and if the translation value information is greater than the value threshold, determining that the product description information satisfies the translation condition.

The performing the weighted calculation on the content score and the association score to determine the translation value information corresponding to the product description information includes: performing a weighted calculation on the content score and the association score of each type of product description information to determine the translation value information corresponding to each type of product description information; the matching the translation value information with the translation condition to determine the product description information that satisfies the translation condition includes: respectively determining whether the translation value information of each type of product description information is greater than a value threshold; and if the translation value information is greater than the value threshold, determining that the type of product description information satisfies the translation condition.

Step 510, performing a translation process on the to-be-translated information into a second language to determine product description information in the second language.

Step 512, feeding back the product description information in the second language based on the translation service.

In some optional embodiments, the product description information in the second language can be fed back to the client terminal, and the client terminal can display it on the editing page, and the user can adjust the translated sentences accordingly.

In the embodiments of the present application, the translated product description information in the second language can be directly fed back to the client terminal, for example, by displaying the product description information in the second language at the corresponding position on the editing page, such as displaying the title in the first language and the title in the second language at the title position. In some other scenarios, each type of product description information in the second language can also be combined to generate a product page of the product object in the second language; and the product page of the product object in the second language is fed back, so that the user can directly view the translated product page. An adjustment control can also be provided on the product page, and in response to a trigger of the adjustment control, the layout of each type of product description information in the second language can be adjusted, or the translated content can be adjusted.

Thus, the user can conveniently perform translation through the service provided by the cloud, improving the user experience.

An embodiment of the present application provides a data verification capability to avoid translating valueless content, greatly reducing translation requests. It can also provide a translation decision-making capability, which can measure the value of the content to be translated, and then apply the limited translation capability to high-value content. On the one hand, the amount of translation is greatly reduced, and on the other hand, the value of the translated unit character is increased.

An embodiment of the present application discovers the performance and value of the content of a product object in different scenarios, extracts corresponding features, and performs content value measurement. Based on the measured content value, the translation value score of the content is calculated, and a decision is made on whether the content needs to be translated. Especially in platform-based cross-border e-commerce scenarios where content changes frequently and global sales are supported, the value utilization rate of unit translation resources can be better realized. In particular, a product object can determine the language for translation based on the region where it is to be sold, and then based on verification and decision-making on the product object information, determine the product description information of the product object that needs to be translated, thus enabling flexible translation.

In the embodiments of the present application, for a plurality of symbol systems that may exist in a language, for example, Chinese includes Simplified Chinese, Traditional Chinese, Cantonese Chinese, and other symbol systems, for data content such as literary works completed using these symbol systems, the expression methods may have significant differences. Therefore, it may be necessary to align the text data to generate text data pairs, thereby obtaining corpora. For example, in an optional embodiment, different symbols may exist for the same language. For example, the Simplified Chinese “ [symbol] ” [Pinyin: Wo Ai Zhong Guo] and the Traditional Chinese “ [symbol] ” [Pinyin: Wo Ai Zhong Guo] are different symbol expressions for the same text meaning in the same language. In some cases, literary works in Simplified Chinese and literary works in Traditional Chinese use the same grammatical expression, for example, novels written by modern writers. In this case, it can be considered that the literary works in Simplified Chinese and the literary works in Traditional Chinese are the same, and there is no need to generate a corpus. In other cases, literary works in Simplified Chinese and literary works in Traditional Chinese use the same grammatical expression, for example, literary works in Traditional Chinese characters written by ancient writers and texts translated into modern language. Because the grammatical expressions between the two are inconsistent, it is difficult to directly determine that the two are the same, and at this time, it may be necessary to generate a corpus. For example, the ancient poem in Traditional Chinese characters “ [symbol] , [symbol] ” [Pinyin: Jian Jia Cang Cang, Bai Lu Wei Shuang] and the modern translation in Simplified Chinese characters “ [symbol] , [symbol] ” [Pinyin: Lu Wei Mi Mi You Cang Cang, Jing Ying Lu Shui Jie Cheng Shuang] have different wording and grammatical expressions, and it may be necessary to perform matching based on feature data such as the title, author, and chapter name of the ancient poem to output a corpus pair. As another example, for the ancient poem in Traditional Chinese characters “ [symbol] , [symbol] ” [Pinyin: Jian Jia Cang Cang, Bai Lu Wei Shuang] and its English translation “The young shoots of reeds are grey, the white dew looks like frost”, it may be necessary to perform a weighted calculation on the mapping relationship between the titles of the ancient poems, the similarity between the titles, the mapping relationship between the authors, the matching degree between the authors, the similarity between the abstracts, and/or the similarity between the content of specific parts to obtain a literary work pair containing different languages, and only then can the bilingual sentence pair (sentence pair, corpus pair) of this ancient poem be obtained. Similarly, a bilingual sentence pair (sentence pair, corpus pair) of the Simplified Chinese poem “ [symbol] , [symbol] ”[Pinyin: Lu Wei Mi Mi You Cang Cang, Jing Ying Lu Shui Jie Cheng Shuang] and its English translation “The young shoots of reeds are grey, the white dew looks like frost” can be obtained.

In this case, to obtain a corpus, different symbol systems of the same language can be considered as different languages. By analogy, for various languages and the various symbol systems within each language, the corpus generation method in the embodiments of the present application can be used to generate corpus pairs. Therefore, regardless of the degree of differences between various languages or language symbol systems, the corpus generation method according to the embodiments of the present application can be used to generate corpus pairs. In other words, as long as the feature data of the data content of different languages or different symbol systems of the same language can be extracted to match the data content of different languages, text data pairs of different languages can be obtained, thereby obtaining corpora of different languages.

In conjunction with the above method, translation can be performed. Therefore, the first language and the second language can also be different symbol systems under the same language, such as Chinese including Simplified Chinese, Traditional Chinese, Cantonese Chinese, and other symbol systems. Translation can be performed between these symbol systems.

It should be noted that the embodiments of the present application may involve the use of user data. In practical applications, under the condition of complying with the requirements of applicable laws and regulations of the country where it is located (for example, with the user's explicit consent, and with effective notification to the user, etc.), the user-specific personal data is used in the solutions described in this text within the scope permitted by applicable laws and regulations.

It should be noted that, for the method embodiments, for the sake of simple description, they are all expressed as a series of action combinations. However, those skilled in the art should know that the embodiments of the present application are not limited by the described sequence of actions, because according to the embodiments of the present application, some steps can be performed in other orders or simultaneously. Secondly, those skilled in the art should also know that the embodiments described in the description are all preferred embodiments, and the actions involved are not necessarily required by the embodiments of the present application.

On the basis of the above embodiments, an embodiment of the present application also provides a translation apparatus for product object information, applied to electronic devices such as client terminal devices and server terminal devices. As shown in FIG. 6, the apparatus includes:
an obtaining module 602, configured to obtain product object information of a product object, the product object information including product description information in a first language;
an analysis module 604, configured to analyze the product object information to determine product description information that satisfies a translation condition, as to-be-translated information;
a translation module 606, configured to perform a translation process on the to-be-translated information into a second language to determine product description information in the second language.

In summary, the product object information of the product object is analyzed, wherein the product object information includes product description information in a first language. The product description information that satisfies a translation condition is determined through analysis and used as to-be-translated information, thereby quickly filtering the product description information that needs to be translated and reducing the amount of data for translation. Then, a translation process is performed on the to-be-translated information into a second language to determine the product description information in the second language. The to-be-translated information is translated in a targeted manner, which improves translation efficiency. The translation process is controllable and can guarantee the translation time, improving user experience.

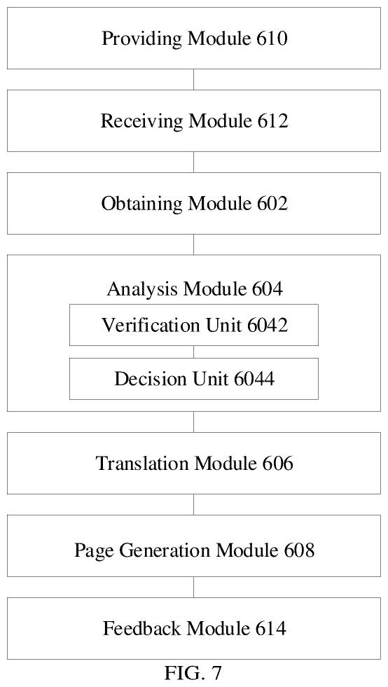

As shown in FIG. 7, the analysis module 604 includes: a verification unit 6042 and a decision unit 6044;
the verification unit 6042 is configured to verify the product object information to determine product object information that satisfies a verification rule;
the decision unit 6044 is configured to analyze the product object information that satisfies the verification rule to determine the product description information that satisfies the translation condition.

The product object information further includes user level information and a review status; the verification unit 6042 is configured to verify characters of the product description information in the product object information according to a character verification rule to determine product description information that conforms to the character verification rule; verify the user level information in the product object information according to a level verification rule to determine product object information where the user level information conforms to the level verification rule; verify the review status in the product object information according to a status verification rule to determine product object information where the review status conforms to the status verification rule.

The decision unit 6044 is configured to analyze the product object information to determine translation value information corresponding to the product description information; and match the translation value information with the translation condition to determine the product description information that satisfies the translation condition.

The decision unit 6044 is configured to determine a content score and an association score based on the product object information; and perform a weighted calculation on the content score and the association score to determine the translation value information corresponding to the product description information.

The decision unit 6044 is configured to analyze according to a type of the product description information to determine the content score of each type of product description information and corresponding first weight information.

The product object information further includes: sales region information, a product type, an access volume, and brand information; the decision unit 6044 is configured to determine a language score and second weight information based on the sales region information of the product object information; determining a product type based on the product object information and determine an access frequency score and third weight information based on the product type; determine an access volume score and fourth weight information based on the access volume of the product object information; determine a brand score and fifth weight information based on the brand information of the product object information.

The decision unit 6044 is configured to determine whether the translation value information of the product description information is greater than a value threshold; if the translation value information is greater than the value threshold, determine that the product description information satisfies the translation condition.

The decision unit 6044 is configured to perform a weighted calculation on the content score and the association score of each type of product description information to determine the translation value information corresponding to each type of product description information; and respectively determine whether the translation value information of each type of product description information is greater than a value threshold; if the translation value information is greater than the value threshold, determine that the type of product description information satisfies the translation condition.

The apparatus further includes: a page generation module 608, configured to combine each type of product description information in the second language to generate a product page of the product object in the second language.

In an optional embodiment, the above translation apparatus for product object information further includes the following modules:
a providing module 610, configured to provide an editing page, the editing page including an editing control, for determining a product object identifier of a to-be-translated product object based on the editing control;
a receiving module 612, configured to receive a translation request and obtain a product object identifier from the translation request;
an obtaining module 602, configured to obtain product object information of a product object based on the product object identifier, the product object information including product description information in a first language;
an analysis module 604, configured to analyze the product object information to determine product description information that satisfies a translation condition, as to-be-translated information;
a translation module 606, configured to perform a translation process on the to-be-translated information into a second language to determine product description information in the second language;
a page generation module 608, configured to combine each type of product description information in the second language to generate a product page of the product object in the second language;
a feedback module 614, configured to feed back the product page of the product object in the second language.

In an optional embodiment, the above translation apparatus for product object information further includes the following modules:
a providing module 610, configured to provide a translation service to a client terminal;
a receiving module 612, configured to receive a product object identifier fed back through the translation service;
an obtaining module 602, configured to obtain product object information of a product object based on the product object identifier, the product object information including product description information in a first language;
an analysis module 604, configured to analyze the product object information to determine product description information that satisfies a translation condition, as to-be-translated information;
a translation module 606, configured to perform a translation process on the to-be-translated information into a second language to determine product description information in the second language;
a feedback module 614, configured to feed back the product description information in the second language based on the translation service.

In summary, the product object information of the product object is analyzed, wherein the product object information includes product description information in a first language. The product description information that satisfies a translation condition is determined through analysis and used as to-be-translated information, thereby quickly determining the product description information that needs to be translated and reducing the amount of data for translation. Then, a translation process is performed on the to-be-translated information into a second language to determine the product description information in the second language. The to-be-translated information is translated in a targeted manner, which improves translation efficiency.

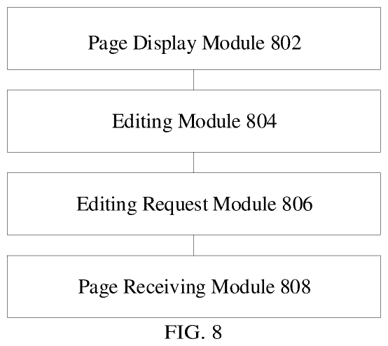

On the basis of the above embodiments, one embodiment also provides a translation apparatus for product object information, applied to electronic devices such as client terminal devices. As shown in FIG. 8, the apparatus includes:
a page display module 802, configured to display an editing page, the editing page including an editing control;
an editing module 804, configured to, in response to a trigger of the editing control, determine a product object identifier of a to-be-translated product object;
an editing request module 806, configured to generate a translation request based on the product object identifier and send the translation request;
a page receiving module 808, configured to receive a product page of the product object in a second language, wherein the product page of the product object in the second language is generated by combining each type of product description information in the second language, the each type of product description information in the second language is obtained by translating to-be-translated information, the to-be-translated information is determined based on product description information that satisfies a translation condition, and the product description information that satisfies the translation condition is determined based on an analysis of product object information.

The embodiments of the present application provides a data verification capability to avoid translating valueless content, greatly reducing translation requests. It can also provide a translation decision-making capability, which can measure the value of the content to be translated, and then apply the limited translation capability to high-value content. On the one hand, the amount of translation is greatly reduced, and on the other hand, the value of the translated unit character is increased.

The embodiments of the present application discovers the performance and value of the content of a product object in different scenarios, extracts corresponding features, and performs content value measurement. Based on the measured content value, the translation value score of the content is calculated, and a decision is made on whether the content needs to be translated. Especially in platform-based cross-border e-commerce scenarios where content changes frequently and global sales are supported, the value utilization rate of unit translation resources can be better realized. In particular, a product object can determine the language for translation based on the region where it is to be sold, and then based on verification and decision-making on the product object information, determine the product description information of the product object that needs to be translated, thus enabling flexible translation.

An embodiment of the present application also provides a non-volatile computer-readable storage medium, wherein the storage medium stores one or a plurality of modules (programs), and the one or a plurality of modules, when applied to a device, can cause the device to execute the instructions of the method steps in the embodiments of the present application.

An embodiment of the present application also provides a computer-readable storage medium, wherein the computer-readable storage medium stores computer-executable instructions, and the computer-executable instructions, when executed by a processor, are used to implement the method as described in the embodiments of the present application.

An embodiment of the present application also provides an electronic apparatus, including: a processor, and a memory communicatively connected to the processor; the memory stores computer-executable instructions; the processor executes the computer-executable instructions stored in the memory to implement the method as described in the embodiments of the present application. In the embodiments of the present application, the electronic apparatus includes servers, terminal devices, and other devices.

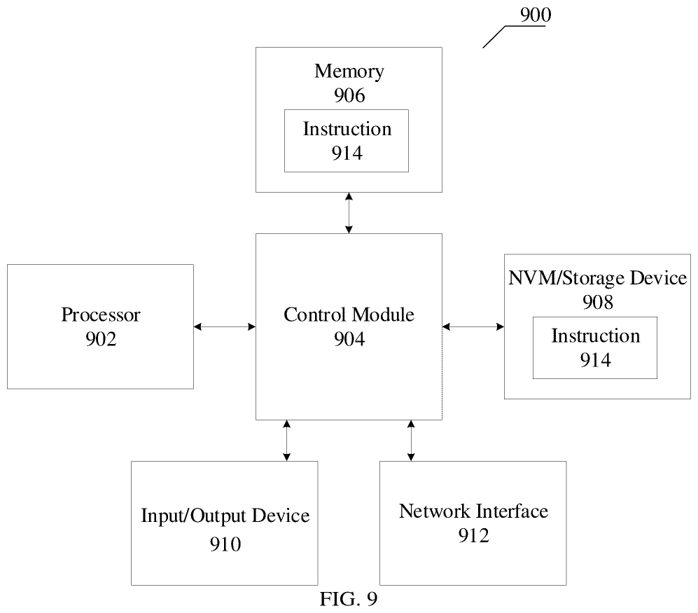

The embodiments of the present disclosure may be implemented using any suitable hardware, firmware, software, or any combination thereof, configured as desired. The apparatus may include electronic devices such as servers (clusters), terminals, etc. FIG. 9 schematically illustrates an exemplary apparatus 900 that may be used to implement various embodiments described in this application.

According to one embodiment, FIG. 9 illustrates an exemplary apparatus 900, which has one or a plurality of processors 902, a control module (chipset) 904 coupled to at least one of the one or a plurality of processors 902, a memory 906 coupled to the control module 904, a non-volatile memory (NVM)/storage device 908 coupled to the control module 904, one or a plurality of input/output devices 910 coupled to the control module 904, and a network interface 912 coupled to the control module 904.

The processor 902 may include one or a plurality of single-core or multi-core processors. The processor 902 may include any combination of general-purpose processors or special-purpose processors (e.g., graphics processors, application processors, baseband processors, etc.). In some embodiments, the apparatus 900 may serve as the server terminal, terminal, etc., described in the embodiments of the present application.

In some embodiments, the apparatus 900 may include one or a plurality of computer-readable media (e.g., memory 906 or NVM/storage device 908) having instructions 914, and one or a plurality of processors 902 configured to execute the instructions 914 in combination with the one or a plurality of computer-readable media to implement modules and thereby perform the actions described in the present disclosure.

According to one embodiment, the control module 904 may include any suitable interface controller to provide any suitable interface to at least one of the one or a plurality of processors 902 and/or to any suitable device or component in communication with the control module 904.

The control module 904 may include a memory controller module to provide an interface to the memory 906. The memory controller module may be a hardware module, a software module, and/or a firmware module.

The memory 906 may be used, for example, to load and store data and/or instructions 914 for the apparatus 900. According to one embodiment, the memory 906 may include any suitable volatile memory, for example, suitable DRAM. In some embodiments, the memory 906 may include Double Data Rate type four Synchronous Dynamic Random-Access Memory (DDR4 SDRAM).

According to one embodiment, the control module 904 may include one or a plurality of input/output controllers to provide an interface to the NVM/storage device 908 and the one or a plurality of input/output devices 910.

For example, the NVM/storage device 908 may be used to store data and/or instructions 914. The NVM/storage device 908 may include any suitable non-volatile memory (e.g., flash memory) and/or may include any suitable one or a plurality of non-volatile storage devices (e.g., one or a plurality of hard disk drives (HDDs), one or a plurality of compact disc (CD) drives, and/or one or a plurality of digital versatile disc (DVD) drives).

The NVM/storage device 908 may include a storage resource that is part of the apparatus 900 installed therein, or it may be accessed by the device without necessarily being part of the device. For example, the NVM/storage device 908 may be accessed over a network via the one or a plurality of input/output devices 910.

The one or a plurality of input/output devices 910 may provide an interface for the apparatus 900 to communicate with any other suitable device. The input/output devices 910 may include communication components, audio components, sensor components, etc. The network interface 912 may provide an interface for the apparatus 900 to communicate over one or a plurality of networks. The apparatus 900 may communicate wirelessly with one or a plurality of components of a wireless network according to any one or a plurality of standards and/or protocols in wireless network standards and/or protocols, for example, accessing a wireless network based on communication standards such as Bluetooth, WiFi, 2G, 3G, 4G, 5G, etc., or their combinations for wireless communication.

According to one embodiment, at least one of the one or a plurality of processors 902 may be logically packaged with one or a plurality of controllers (e.g., a memory controller module) of the control module 904. According to one embodiment, at least one of the one or a plurality of processors 902 may be logically packaged with one or a plurality of controllers of the control module 904 to form a System in Package (SiP). According to one embodiment, at least one of the one or a plurality of processors 902 may be logically integrated on the same die with one or a plurality of controllers of the control module 904. According to one embodiment, at least one of the one or a plurality of processors 902 may be logically integrated on the same die with one or a plurality of controllers of the control module 904 to form a System on Chip (SoC).

In various embodiments, the apparatus 900 may be, but is not limited to: a server, a desktop computing device, or a mobile computing device (e.g., a laptop computing device, a handheld computing device, a tablet computer, a netbook, etc.), or other terminal devices. In various embodiments, the apparatus 900 may have more or fewer components and/or a different architecture. For example, in some embodiments, the apparatus 900 includes one or a plurality of cameras, a keyboard, a liquid crystal display (LCD) screen (including a touch screen display), a non-volatile memory port, a plurality of antennas, a graphics chip, an application-specific integrated circuit (ASIC), and a speaker.

In particular, a master control chip can be used as the processor or control module in the detection apparatus. Sensor data, location information, etc., are stored in the memory or NVM/storage device. The sensor group can serve as an input/output device, and the communication interface may include a network interface.

An embodiment of the present application also provides an electronic apparatus, including: a processor; and a memory, on which executable code is stored. When the executable code is executed, it causes the processor to perform one or a plurality of the methods in the embodiments of the present application. The memory in the embodiments of the present application may store various data, such as target files, data of association between files and applications, and other various data, and may also include user behavior data, etc., thereby providing a data basis for various processing.

An embodiment of the present application also provides one or a plurality of machine-readable media, on which executable code is stored. When the executable code is executed, it causes a processor to perform one or a plurality of the methods in the embodiments of the present application.

For the apparatus embodiments, because they are substantially similar to the method embodiments, the description is relatively simple. For relevant parts, reference can be made to the description of the method embodiments.

The various embodiments in this specification are described in a progressive manner. Each embodiment focuses on the differences from other embodiments, and the same or similar parts between the various embodiments can be referred to each other.

The embodiments of the present application are described with reference to flowcharts and/or block diagrams of methods, terminal devices (systems), and computer program products according to the embodiments of the present application. It should be understood that each process and/or block in the flowcharts and/or block diagrams, and combinations of processes and/or blocks in the flowcharts and/or block diagrams, can be implemented by computer program instructions. These computer program instructions can be provided to a processor of a general-purpose computer, a special-purpose computer, an embedded processor, or other programmable data processing terminal device to produce a machine, such that the instructions executed by the processor of the computer or other programmable data processing terminal device produce an apparatus for implementing the functions specified in one or more processes of the flowchart and/or one or more blocks of the block diagram.

These computer program instructions can also be stored in a computer-readable memory that can direct a computer or other programmable data processing terminal device to work in a specific manner, such that the instructions stored in the computer-readable memory produce an article of manufacture including an instruction apparatus, which implements the functions specified in one or more processes of the flowchart and/or one or more blocks of the block diagram.

These computer program instructions can also be loaded onto a computer or other programmable data processing terminal device, so that a series of operational steps are performed on the computer or other programmable terminal device to produce a computer-implemented process, such that the instructions executed on the computer or other programmable terminal device provide steps for implementing the functions specified in one or more processes of the flowchart and/or one or more blocks of the block diagram.

Although the preferred embodiments of the present application have been described, those skilled in the art can make other changes and modifications to these embodiments once they have learned the basic inventive concepts. Therefore, the appended claims are intended to be interpreted as including the preferred embodiments and all changes and modifications that fall within the scope of the embodiments of the present application.

Finally, it should also be noted that in the present application, relational terms such as “first” and “second” are used merely to distinguish one entity or operation from another entity or operation, and do not necessarily require or imply any such actual relationship or order between these entities or operations. Moreover, the terms “comprising,” “including,” or any other variation thereof are intended to cover a non-exclusive inclusion, such that a process, method, article, or terminal device that includes a series of elements not only includes those elements, but also includes other elements not explicitly listed, or also includes elements inherent to such a process, method, article, or terminal device. In the absence of more restrictions, an element defined by the statement “comprising a . . . ” does not exclude the existence of other identical elements in the process, method, article, or terminal device that includes the said element.

The above provides a detailed introduction to a method for translating product object information, an electronic apparatus, and a storage medium provided by the present application. Specific examples are used in the present application to explain the principles and implementation methods of the present application. The description of the above embodiments is only for helping to understand the method of the present application and its core ideas. Those of ordinary skill in the art will recognize that specific implementation methods and application scopes may vary in accordance with the principles of the present application. In summary, the content of this specification should not be construed as a limitation on the present application.

What is claimed is:

1. A machine translation method comprising:
providing, by a server, an editing web page on a display, wherein the editing page comprises an editing control, for determining a product object identifier of a to-be-translated product object based on the editing control;
receiving, by the server, a translation request and obtaining, by the server, the product object identifier from the translation request;
obtaining, by the server, product object information of a product object based on the product object identifier, wherein the product object information comprises product description information in a first language;
analyzing, by the server, the product object information to determine product description information that satisfies a translation condition, as to-be-translated information;
performing, by the server, a translation process on the to-be-translated information into a second language to determine product description information in the second language;
combining, by the server, each type of the product description information in the second language to generate a product web page of the product object in the second language; and
transmitting, by the server, the product page of the product object in the second language to a client terminal for display.

2. The machine translation method according to claim 1, wherein the analyzing, by the server, the product object information to determine the product description information that satisfies the translation condition comprises:
verifying the product object information to determine product object information that satisfies a verification rule; and
analyzing the product object information that satisfies the verification rule to determine the product description information that satisfies the translation condition.

3. The machine translation method according to claim 2, wherein the product object information further comprises user level information and a review status; and
the verifying the product object information to determine the product object information that satisfies the verification rule comprises at least one of:
verifying characters of the product description information in the product object information according to a character verification rule to determine product description information that conforms to the character verification rule;
verifying the user level information in the product object information according to a level verification rule to determine product object information where the user level information conforms to the level verification rule; or
verifying the review status in the product object information according to a status verification rule to determine product object information where the review status conforms to the status verification rule.

4. The machine translation method according to claim 2, wherein the analyzing, by the server, the product object information that satisfies the verification rule to determine the product description information that satisfies the translation condition comprises:
analyzing the product object information to determine translation value information corresponding to the product description information; and
matching the translation value information with the translation condition to determine the product description information that satisfies the translation condition.

5. The machine translation method according to claim 4, wherein the analyzing, by the server, the product object information to determine the translation value information corresponding to the product description information comprises:
determining a content score and an association score based on the product object information; and
performing a weighted calculation on the content score and the association score to determine the translation value information corresponding to the product description information.

6. The machine translation method according to claim 5, wherein the determining the content score based on the product object information comprises:
analyzing according to a type of the product description information to determine a content score of each type of the product description information and corresponding first weight information;
wherein the product object information further comprises: sales region information, a product type, an access volume, and brand information; and the determining the association score based on the product object information comprises at least one of:
determining a language score and second weight information based on the sales region information;
determining an access frequency score and third weight information based on the product type;
determining an access volume score and fourth weight information based on the access volume; or
determining a brand score and fifth weight information based on the brand information.

7. The machine translation method according to claim 4, wherein the matching the translation value information with the translation condition to determine the product description information that satisfies the translation condition comprises:
determining whether the translation value information of the product description information is greater than a value threshold; and
if the translation value information is greater than the value threshold, determining that the product description information satisfies the translation condition.

8. The machine translation method according to claim 6, wherein the performing the weighted calculation on the content score and the association score to determine the translation value information corresponding to the product description information comprises:
performing a weighted calculation on the content score and the association score of each type of the product description information to determine the translation value information corresponding to each type of the product description information; and
the matching the translation value information with the translation condition to determine the product description information that satisfies the translation condition comprises:
respectively determining whether the translation value information of each type of the product description information is greater than a value threshold; and
if the translation value information is greater than the value threshold, determining that the type of the product description information satisfies the translation condition.

9. A machine translation method for translating product object information comprising:
displaying, by a client terminal, an editing web page, wherein the editing web page comprises an editing control;
in response to a trigger of the editing control, determining, by the client terminal, a product object identifier of a to-be-translated product object;
generating, by the client terminal, a translation request based on the product object identifier and sending, by the client terminal, the translation request to a server; and
receiving, by the client terminal, a product web page of the product object in a second language, wherein the product web page of the product object in the second language is generated by the server by combining each type of product description information in the second language, the each type of the product description information in the second language is obtained by translating to-be-translated information, the to-be-translated information is determined based on product description information that satisfies a translation condition, and the product description information that satisfies the translation condition is determined based on an analysis of product object information.

10. The machine translation method according to claim 9, wherein the analysis of product object information comprises:
verifying the product object information to determine product object information that satisfies a verification rule; and
analyzing the product object information that satisfies the verification rule to determine the product description information that satisfies the translation condition.

11. The machine translation method according to claim 10, wherein the product object information further comprises user level information and a review status; and
the verifying the product object information to determine the product object information that satisfies the verification rule comprises at least one of:
verifying characters of the product description information in the product object information according to a character verification rule to determine product description information that conforms to the character verification rule;
verifying the user level information in the product object information according to a level verification rule to determine product object information where the user level information conforms to the level verification rule; or
verifying the review status in the product object information according to a status verification rule to determine product object information where the review status conforms to the status verification rule.

12. The machine translation method according to claim 10, wherein the analysis of product object information comprises:
analyzing the product object information to determine translation value information corresponding to the product description information; and
matching the translation value information with the translation condition to determine the product description information that satisfies the translation condition.

13. The machine translation method according to claim 12, wherein the analyzing the product object information to determine the translation value information corresponding to the product description information comprises:
determining a content score and an association score based on the product object information; and
performing a weighted calculation on the content score and the association score to determine the translation value information corresponding to the product description information.

14. The machine translation method according to claim 13, wherein the determining the content score based on the product object information comprises:
analyzing according to a type of the product description information to determine a content score of each type of the product description information and corresponding first weight information;
wherein the product object information further comprises: sales region information, a product type, an access volume, and brand information; and the determining the association score based on the product object information comprises at least one of:
determining a language score and second weight information based on the sales region information;
determining an access frequency score and third weight information based on the product type;
determining an access volume score and fourth weight information based on the access volume; or
determining a brand score and fifth weight information based on the brand information.

15. The machine translation method according to claim 12, wherein the matching the translation value information with the translation condition to determine the product description information that satisfies the translation condition comprises:
determining whether the translation value information of the product description information is greater than a value threshold; and
if the translation value information is greater than the value threshold, determining that the product description information satisfies the translation condition.

16. The machine translation method according to claim 14, wherein the performing the weighted calculation on the content score and the association score to determine the translation value information corresponding to the product description information comprises:
performing a weighted calculation on the content score and the association score of each type of the product description information to determine the translation value information corresponding to each type of the product description information; and
the matching the translation value information with the translation condition to determine the product description information that satisfies the translation condition comprises:
respectively determining whether the translation value information of each type of the product description information is greater than a value threshold; and
if the translation value information is greater than the value threshold, determining that the type of the product description information satisfies the translation condition.

17. An electronic device comprising:
one or more processors; and
one or more computer-readable memories coupled to the one or more processors and having instructions stored thereon that are executable by the one or more processors to perform one or more operations comprising:
providing an editing web page on a display, wherein the editing page comprises an editing control, for determining a product object identifier of a to-be-translated product object based on the editing control;
receiving a translation request and obtaining the product object identifier from the translation request;
obtaining product object information of a product object based on the product object identifier, wherein the product object information comprises product description information in a first language;
analyzing the product object information to determine product description information that satisfies a translation condition, as to-be-translated information;
performing a translation process on the to-be-translated information into a second language to determine product description information in the second language;
combining each type of the product description information in the second language to generate a product web page of the product object in the second language; and
transmitting the product page of the product object in the second language to a client terminal for display.

18. The electronic device according to claim 17, wherein the analyzing the product object information to determine the product description information that satisfies the translation condition comprises:
verifying the product object information to determine product object information that satisfies a verification rule; and
analyzing the product object information that satisfies the verification rule to determine the product description information that satisfies the translation condition.

19. The electronic device according to claim 18, wherein the product object information further comprises user level information and a review status; and
the verifying the product object information to determine the product object information that satisfies the verification rule comprises at least one of:
verifying characters of the product description information in the product object information according to a character verification rule to determine product description information that conforms to the character verification rule;
verifying the user level information in the product object information according to a level verification rule to determine product object information where the user level information conforms to the level verification rule; or
verifying the review status in the product object information according to a status verification rule to determine product object information where the review status conforms to the status verification rule.

20. The electronic device according to claim 18, wherein the analyzing the product object information that satisfies the verification rule to determine the product description information that satisfies the translation condition comprises:
analyzing the product object information to determine translation value information corresponding to the product description information; and
matching the translation value information with the translation condition to determine the product description information that satisfies the translation condition.
